(19) United States
(12) Patent Application Publication
(10) Pub. No.: US 2022/0385949 A1
(43) Pub. Date: Dec. 1, 2022

(54) BLOCK-BASED COMPRESSIVE AUTO-ENCODER

(71) Applicant: InterDigital VC Holdings, Inc., Wilmington, DE (US)

(72) Inventors: Franck GALPIN, Cesson-Sevigne (FR); Fabien RACAPE, Los Altos, CA (US); Jean BEGAINT, Menlo Park, CA (US); Thierry DUMAS, Cesson-Sevigne (FR)

(21) Appl. No.: 17/772,088

(22) PCT Filed: Dec. 14, 2020
(86) PCT No.: PCT/US2020/064862

§ 371 Date: Apr. 26, 2022

(30) Foreign Application Priority Data
Dec. 19, 2019 (EP) 19306703.0

(51) Int. Cl. H04N 19/91; H04N 19/105; H04N 19/132; H04N 19/176

(52) U.S. Cl. CPC H04N 19/91; H04N 19/105; H04N 19/132; H04N 19/176

(57) ABSTRACT

In one implementation, a picture is partitioned into multiple blocks, with uniform or different block sizes. Each block is compressed by an auto-encoder, which may comprise a deep neural network and entropy encoder. The compressed block may be reconstructed or decoded with another deep neural network. Quantization may be used in the encoder side, and de-quantization at the decoder side. When the block is encoded, neighboring blocks may be used as causal information. Latent information can also be used as input to a layer at the encoder or decoder. Vertical and horizontal position information can further be used to encode and decode the image block. A secondary network can be applied to the position information before it is used as input to a layer of the neural network at the encoder or decoder. To reduce blocking artifact, the block may be extended before being input to the encoder.

### TECHNICAL FIELD

The present embodiments generally relate to a method and an apparatus for video encoding or decoding, by using deep neural networks.

### BACKGROUND

In conventional image or video coding, recent codecs already show the benefit of block-based coding. However, in recent deep learning-based image or video compression, the full image is usually used, for example, the whole picture is fed into an auto-encoder to compress the picture.

### SUMMARY

According to an embodiment, a method of video decoding is provided, comprising: accessing a bitstream including a picture, said picture having a plurality of blocks; entropy decoding said bitstream to generate a set of values for a block of said plurality of blocks; applying a neural network to said set of values to generate a block of picture samples for said block, said neural network having a plurality of network layers, wherein each network layer of said plurality of network layers performs linear and non-linear operations.

According to an embodiment, a method of video encoding is provided, comprising: accessing a picture, said picture partitioned into a plurality of blocks; forming an input based on at least a block of said picture; applying a neural network to said input to form output coefficients, said neural network having a plurality of network layers, wherein each network layer of said plurality of network layers performs linear and non-linear operations; and entropy encoding said output coefficients.

According to another embodiment, an apparatus for video decoding is provided, comprising one or more processors, wherein said one or more processors are configured to: access a bitstream including a picture, said picture having a plurality of blocks; entropy decode said bitstream to generate a set of values for a block of said plurality of blocks; apply a neural network to said set of values to generate a block of picture samples for said block, said neural network having a plurality of network layers, wherein each network layer of said plurality of network layers performs linear and non-linear operations.

According to another embodiment, an apparatus for video encoding is provided, comprising one or more processors, wherein said one or more processors are configured to: access a picture, said picture partitioned into a plurality of blocks; form an input based on at least a block of said picture; applying a neural network to said input to form output coefficients, said neural network having a plurality of network layers, wherein each network layer of said plurality of network layers performs linear and non-linear operations; and entropy encode said output coefficients.

According to another embodiment, an apparatus of video decoding is provided, comprising: means for accessing a bitstream including a picture, said picture having a plurality of blocks; means for entropy decoding said bitstream to generate a set of values for a block of said plurality of blocks; means for applying a neural network to said set of values to generate a block of picture samples for said block, said neural network having a plurality of network layers, wherein each network layer of said plurality of network layers performs linear and non-linear operations.

According to another embodiment, an apparatus of video encoding is provided, comprising: means for accessing a picture, said picture partitioned into a plurality of blocks; means for forming an input based on at least a block of said picture; means for applying a neural network to said input to form output coefficients, said neural network having a plurality of network layers, wherein each network layer of said plurality of network layers performs linear and non-linear operations; and means for entropy encoding said output coefficients.

### BRIEF DESCRIPTION OF THE DRAWINGS

FIG. 1 illustrates a block diagram of a system within which aspects of the present embodiments may be implemented.

FIG. 2 illustrates a block diagram of an auto-encoder.

FIG. 3 illustrates a block diagram of an embodiment of a video encoder.

FIG. 4 illustrates a block diagram of an embodiment of a video decoder.

FIG. 5 illustrates image partitioning and scanning order.

FIG. 6 illustrates four auto-encoders with different causal information input, according to an embodiment.

FIG. 7 illustrates examples of an encoder and decoder with input context, according to an embodiment.

FIG. 8 illustrates input border extension, according to an embodiment.

FIG. 9 illustrates an auto-encoder with border extension, according to an embodiment.

FIG. 10 illustrates block reconstruction using overlapping borders, according to an embodiment.

FIG. 11 illustrates a training sequence of all cases, according to an embodiment.

FIG. 12 illustrates unification of the different causal information inputs, according to an embodiment.

FIG. 13 illustrates using latent input as neighboring information, according to an embodiment.

FIG. 14 illustrates using latent input as neighboring information, according to another embodiment.

FIG. 15 illustrates a spatial localization network, according to an embodiment.

FIG. 16 illustrates a spatial localization network, according to another embodiment.

FIG. 17 illustrates an example of adaptive size partitioning, according to an embodiment.

FIG. 18 illustrates neighboring information extraction, according to an embodiment.

FIG. 19 illustrates RDO competition between full block encoding and split block encoding, according to an embodiment.

FIG. 20 illustrates joint training of auto-encoders and post-filters, according to an embodiment.

FIG. 21 illustrates a process of encoding, according to an embodiment.

FIG. 22 illustrates a process of decoding, according to an embodiment.

### DETAILED DESCRIPTION

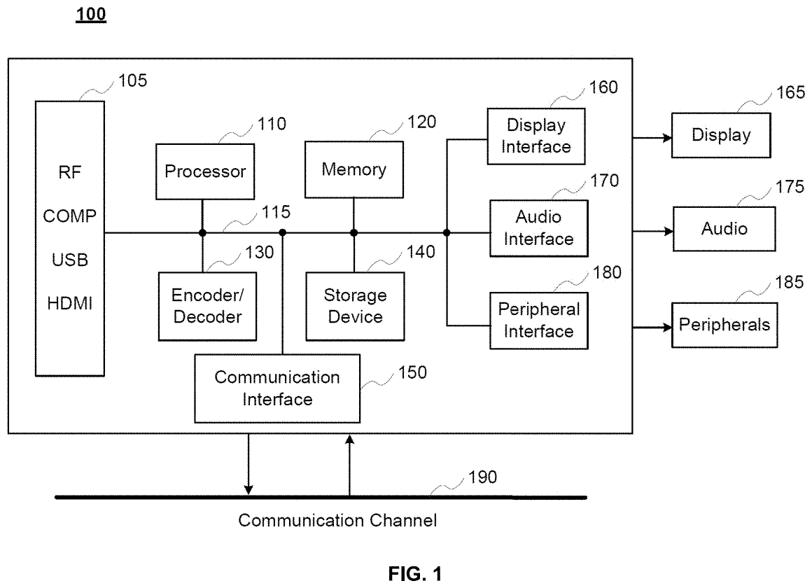

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

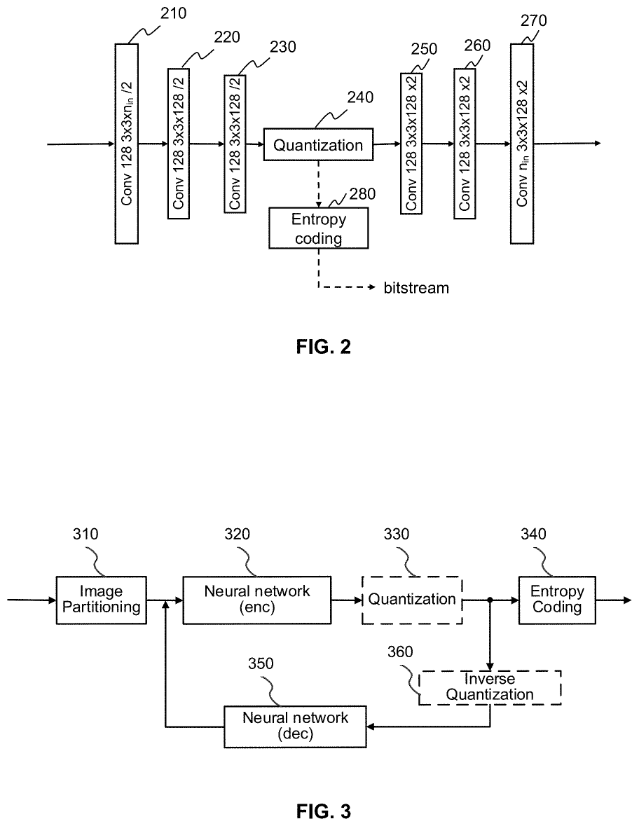

FIG. 2 illustrates a typical auto-encoder architecture. In recent deep learning-based image or video compression, the full image is usually used as input to an encoder (i.e., the entire image is processed as a whole by the deep neural network). In this auto-encoder composed of three convolutional layers (210, 220, 230) and associated activation layer (for example, a ReLU or a Generalized Divisive Normalization (GDN), etc.), the first layer performs 128 3×3×nᵢₙ convolutions (assuming an input with nᵢₙ channels, e.g., nᵢₙ=3 when there are three color components), the remaining layers perform 128 3×3×128 convolutions, and each layer is associated with a down-sampling (denoted by/2). In this example, there are three layers, the number of convolutions for a particular layer is 128, and the size of the convolution kernel is 3×3 spatially. In general, an auto-encoder can have a different number of layers, a different number of convolutions, and a different kernel size from what is shown in FIG. 2, and the kernel sizes can be different for different layers. The layer type can also be different (for example a fully connected layer). The output coefficients are then quantized (240). The quantized coefficients are entropy coded without loss (280) to form the bitstream. At the decoder side, deconvolution (250, 260, 270) is performed to reconstruct the image, either with a transpose convolution or a classic upscaling (denoted by ×2) operator followed by a convolution.

Note that this simple example omits many details, especially on the strategy for the entropy coding of the coefficients. In this example, the whole image is fed into the auto-encoder and each coefficient transmitted is used at most in the reconstruction of an area of 36×36 pixels in the reconstructed image. However, there is no particular region boundaries for each decoded coefficient, and each final pixel depends, potentially, on the value of many coefficients spatially located around this pixel.

The present application proposes compressive auto-encoders working on image parts (as opposed to the whole image). The image partitioning can be handled in the DNN design in order to reduce data redundancy. Classical image/video partitioning scheme can be used, for example, regular block splitting as in JPEG and H.264/AVC, quad-tree partitioning as in H.265/HEVC, or more advanced splitting as in H.266/VVC.

Some advantages of using block-based (or region-based) encoding are described as follows:
Offer more flexibility at the encoder side (e.g., quality control, Region of Interest etc.).
Offer a maximum bound on the decoder complexity (for example, by fixing the maximum block size to 128×128).
Offer a possible progressive decoding.
Improve performances by specializing the encoders by the block size.

FIG. 3 illustrates an example of a block-based encoder, according to an embodiment. In the present application, the terms “reconstructed” and “decoded” may be used interchangeably, the terms “encoded” or “coded” may be used interchangeably, and the terms “image”, “picture” and “frame” may be used interchangeably. Usually, but not necessarily, the term “reconstructed” is used at the encoder side while “decoded” is used at the decoder side.

In FIG. 3, to encode a video sequence with one or more pictures, a picture is partitioned into multiple image blocks. In the encoder, a picture is encoded by the encoder elements as described below. The picture to be encoded is processed in units of image blocks (310). Each image block is encoded using an auto-encoder, which includes a neural network (320) that performs linear and non-linear operations. The neural network can be the one as shown in FIG. 2, or can be a variation thereof, for example, with different convolution kernel sizes, different types of layers, and different number of layers.

The output from the neural network can then be quantized (330). The quantized values are entropy coded (340) to output a bitstream. It should be noted that quantization is not mandatory if the network itself is already in integers because in that case the quantization is “included” in the network during the training.

If encoding the current block is based on other reconstructed blocks, the encoder can also decode the encoded block to provide causal information. The quantized values are de-quantized (360). The dequantized values are used to reconstruct the block by using another neural network (350), which performs linear and non-linear operations. Generally, this neural network (350) used for decoding performs the inverse operations of the neural network (320) used for encoding.

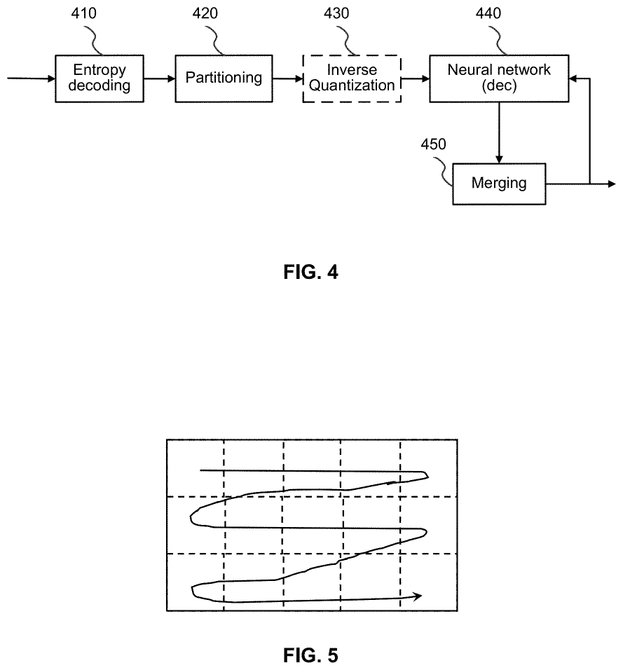

FIG. 4 illustrates a block diagram of an example of a block-based decoder. In particular, the input of the decoder includes a video bitstream, which may be generated by the video encoder as illustrated in FIG. 3. The bitstream is first entropy decoded (410). The picture partitioning information indicates the manner a picture is split into image blocks. The decoder may therefore divide (420) the picture into image blocks, according to the decoded picture partitioning information. The entropy decoded blocks can then be de-quantized (430). Similar to the encoder side, it should be noted that de-quantization is not mandatory if the network itself is already in integers. The de-quantized block is decoded using a neural network (440), which performs linear and non-linear operations. Generally, in order to decode the bitstream properly, this neural network (440) used at the decoder side should be the same as the neural network (350) used for decoding at the encoder side. Different decoded blocks are merged (450) to form the decoded picture. When causal information is used for decoding, the decoded blocks are stored and provided as input to the neural network. In FIG. 2, FIG. 3 and FIG. 4, both the encoder side and decoder side are illustrated. As shown in these figures, the decoder side typically performs inverse operations to the encoder side. In the present application, various embodiments described below are mainly at the encoder side. However, the modifications on the encoder side generally also imply corresponding modifications to the decoder side.

In the following, we first assume that the image has been partitioned into uniform non-overlapping blocks and that each block is coded sequentially, following the raster scan order as illustrated in FIG. 5. Additional embodiments handling other block sizes will then be detailed. Note that the principle explained also applies to other scanning orders, as long as some previously reconstructed neighboring blocks are available during the decoding of a particular block.

Each block is composed of a set of pixels, having at least one component. Typically, a pixel has three components (for example {R, G and B}, or {Y, U and V}). Note that the proposed methods also apply to other “image-based” information such as a depth map, a motion-field, etc.

We assume that each block is compressed using a compressive auto-encoder, for example, as shown in FIG. 2. Typically, an auto-encoder is defined as a network with two parts: the first part (called the encoder) takes an input and processes it in order to produce a representation (usually with a lower dimension or entropy compared to the input). The second part uses this latent representation and aims at recovering the original input.

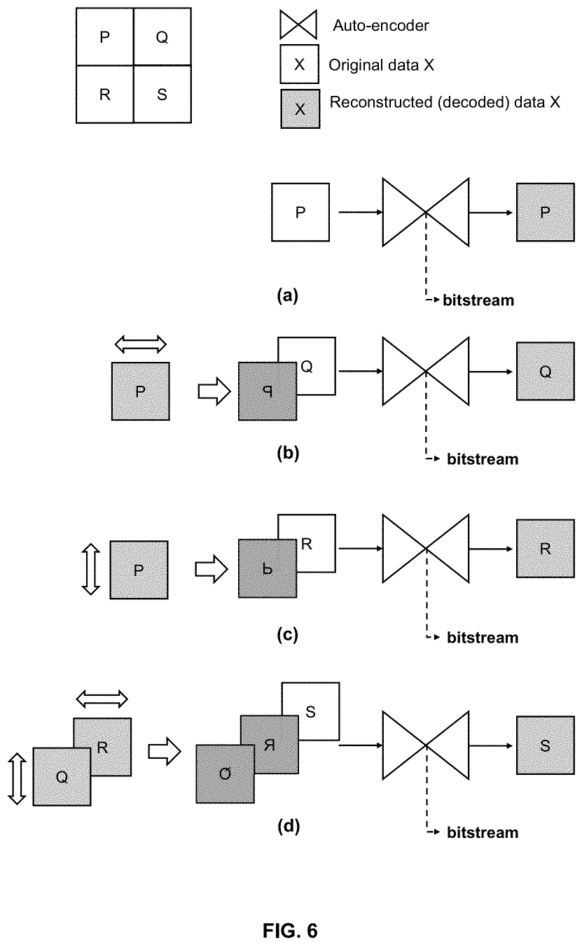

FIG. 6 shows four auto-encoders that can be used to encode image blocks. In the following, we describe in detail the input and output of each auto-encoder. On the top of FIG. 6, we show the spatial layout of the block (namely P, Q, R and S). When a letter is rotated (or mirrored), it means the corresponding data (i.e., pixel matrices) are rotated or mirrored.

Case 1—Corner Case

The first case, as illustrated in FIG. 6(a) is the top-left corner case where no causal information is available. The auto-encoder is similar to a regular auto-encoder, taking one block of pixel P as input and outputting the reconstructed block. The corresponding bitstream is sent to the decoder.

Case 2—Top Row Case

The second case, as illustrated in FIG. 6(b) is the top row case where only left information is available. The auto-encoder inputs are the block to be encoded (Q in the figure) and the reconstructed left block P which has been mirrored horizontally. By mirroring the block P, the spatial correlation with pixels of Q is increased. In particular, by denoting samples of block P as P(i, j) using the conventional matrix notation where i and j are row and column indices ranging from 1 to h and 1 to w respectively, then the input is mirrored as P′(i, j)=P(i, w+1−j), where P′ denotes the mirrored block P. The corresponding bitstream is sent to the decoder.

Case 3—Left Column Case

This case, as illustrated in FIG. 6(c), is the left column case where only top information is available. It is similar in principle to the previous case. The auto-encoder inputs are the block to be encoded (R in the figure) and the reconstructed left block P which has been mirrored vertically. By mirroring the block P, the spatial correlation with each pixel of R is increased. In particular, by denoting samples of block P as P(i, j) using the conventional matrix notation where i and j are row and column indices ranging from 1 to h and 1 to w respectively, then the input is mirrored as P′(i,j)=P(h+1−i,j), where P′ denotes the mirrored block P. The corresponding bitstream is sent to the decoder. The auto-encoder is similar in principle to the one of the previous cases.

Case 4—General Case

The last case, as illustrated in FIG. 6(d), is the general case where both top and left information are available. It is similar in principle to the previous cases, but two information channels are added. The auto-encoder inputs are the block to be encoded (S in the figure), the reconstructed top block Q which has been mirrored vertically, and the reconstructed left block R which has been mirrored horizontally. By mirroring the block Q, the top pixels of S are now better spatially correlated with the top pixels of Qₘᵢᵣᵣₒᵣ. In particular, by denoting samples of block Q as Q(i, j) using the conventional matrix notation where i and j are row and column indices ranging from 1 to h and 1 to w respectively, then the input is mirrored as Q′(i, j)=Q(h+1−i, j), where Q′ denotes the mirrored block Q. By mirroring the block R, the spatial correlation between the left pixels of S with the left pixel of Rₘᵢᵣᵣₒᵣ is increased. In particular, by denoting samples of block R as R(i, j) using the conventional matrix notation where i and j are row and column indices ranging from 1 to h and 1 to w respectively, then the input is mirrored as R′(i, j)=R(i, w+1−j), where R′ denotes the mirrored block R. The corresponding bitstream is sent to the decoder.

The auto-encoder is similar in principle to the previous ones, but three concatenated channels are used instead of one. The concatenation refers to the usual tensor concatenation where each layer of each block forms a tensor of dimension w×h×d where w and his the block size (width and height) and d is the depth of the tensor, i.e., d=3 in this case if each block has one component only.

Case 4—Variant 1

According to Another Embodiment, in the General Case where Top and Left Blocks are available, the top-left block P is also added to the auto-encoder inputs. The auto-encoder inputs are similar to the ones presented in the previous general case with an additional channel. The reconstructed top left block P has been mirrored horizontally and vertically, to increase the correlation with each pixel of S.

Example of Auto-Encoders with Input Context

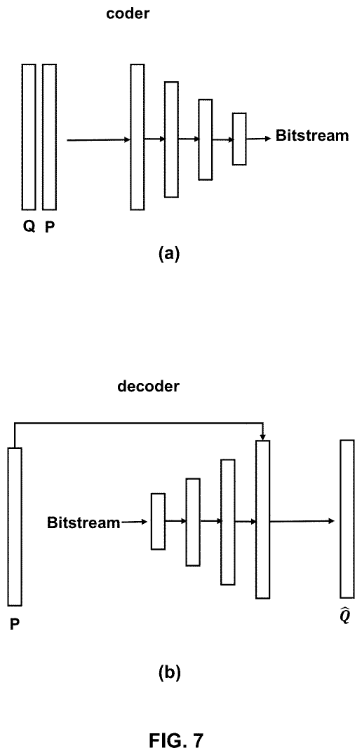

FIG. 7(a) shows an auto-encoder where information P is provided as an input channel in order to encode Q. In this example, the encoder is composed of four convolutional layers, each followed by an activation layer and a down-sampling. Note that in the following examples, the quantization, entropy encoding, entropy decoding and de-quantization modules are omitted for brevity.

Symmetrically, the decoder as illustrated in FIG. 7(b) is composed of four deconvolution layers, each followed by an activation layer and an up-sampling. The input channel P is also input in the last layer of the decoder, concatenated with the output of the previous layer.

Note that other layers might be used for the auto-encoder such as the generalized divisive normalization layer, normalization layer etc.

Input Extension

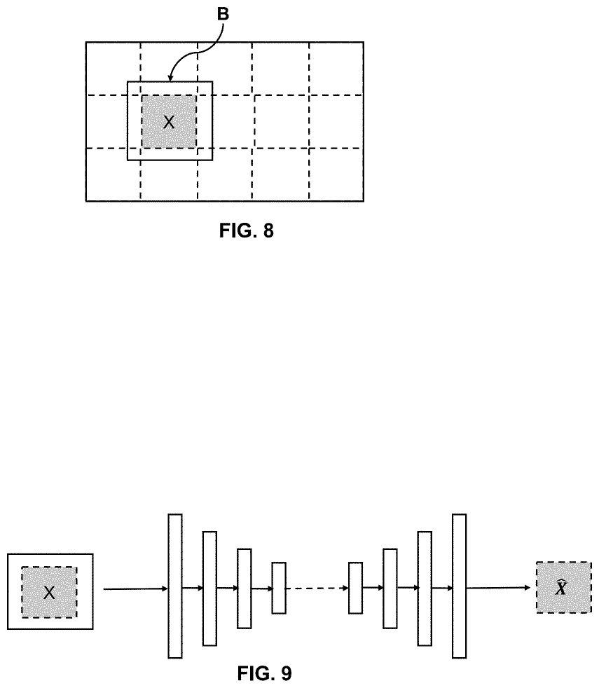

As the image is encoded sequentially per block, in order to decrease the blocking artifacts, in a variant, an extended version of the block X to encode is input in the auto-encoder, as illustrated in FIG. 8. Typically, a border B of size N is added to the input block X, by taking the pixel in the original image. The output of the decoder is the reconstructed block \hat{X}. Therefore, during the training stage, the loss only depends on the reconstructed pixel in block X, as illustrated in FIG. 9.

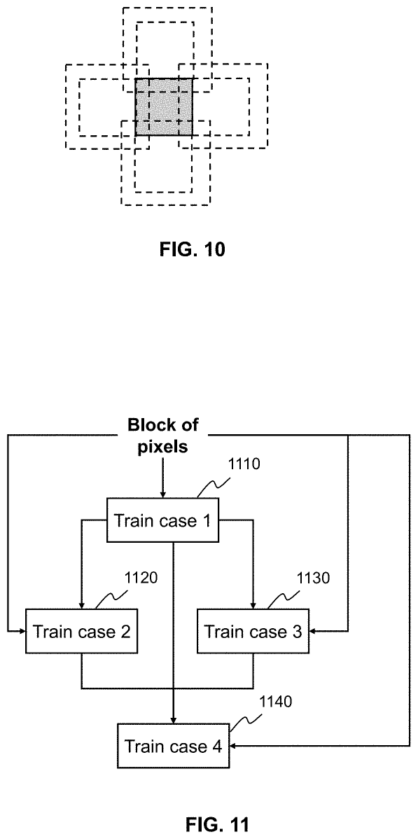

In another variant, the border B is also reconstructed by the decoder, but during the training stage the reconstruction error associated with the border is weighted by a factor α less or equal to 1: [symbol] =∥X−\hat{X}∥+α∥B−\hat{B}∥. For the final reconstruction, the overlapping borders are used in a weighted average with the current block to obtain the final block, as illustrated in FIG. 10.

Training Process

The auto-encoders as described above can be trained sequentially, as illustrated in FIG. 11. In this embodiment, first the top-left (case 1) auto-encoder is trained (1110). It does not require other information as input and can be trained as a regular auto-encoder. The case 2 is then trained (1120), by using the output reconstruction of the first auto-encoder as an input (left information available). The case 3 is also trained (1130) similarly, using output of case 1 (optionally using also output of case 2). Finally, the case 4 is trained (1140) using output of both cases 2 and 3 (optionally using also output of case 1).

Unification of Different Cases

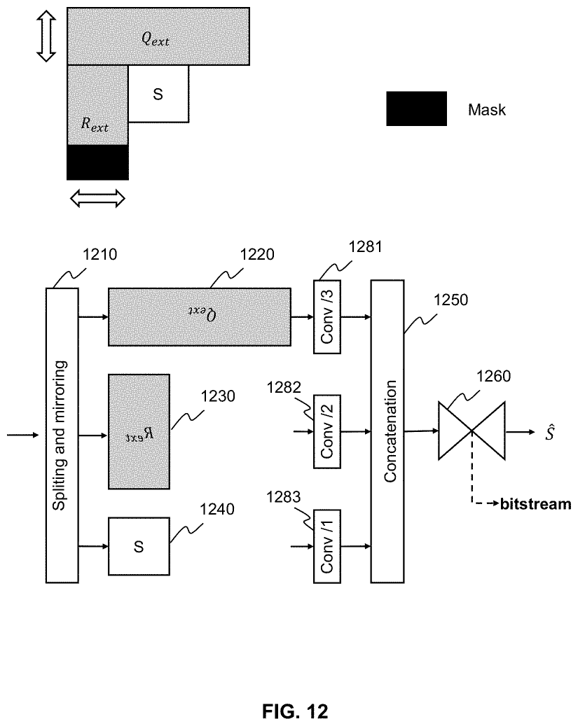

As shown in FIG. 11, a drawback of the method is that four different auto-encoders need to be trained. To improve this, a variant consists in training a single auto-encoder, where this auto-encoder is always fed (1210) with the extended reconstructed top block Qₑₓₜ and the extended reconstructed left block Rₑₓₜ, as illustrated in FIG. 12. When parts of an extended reconstructed block are either not available (because S lies against an image border) or not decoded yet, these parts are masked (see FIG. 12).

Similar to Case 4, the extended reconstructed top block Qₑₓₜ is mirrored vertically (1220) so that the top pixels of S are better spatially correlated with the top pixels of the mirrored version of Qₑₓₜ. The extended reconstructed left block Rₑₓₜ is mirrored horizontally (1230) so that the left pixels of S are better spatially correlated with the left pixels of the mirrored version of Rₑₓₜ. The mirrored version of Qₑₓₜ (1220), that of Rₑₓₜ (1230), and S (1240) are each fed into a convolutional layer (1281, 1282, 1283), the down-sampling factor of each convolutional layer being chosen such that the output feature maps have the same spatial dimensions. All the resulting feature maps are concatenated (1250) and fed into the auto-encoder (1260) to obtain reconstructed block Ŝ.

Latent Input

In an example as illustrated in FIG. 13, the previously decoded information is used not as a block of pixels input, but instead as the latent information (e.g., input of the last layer) to be used by the decoder.

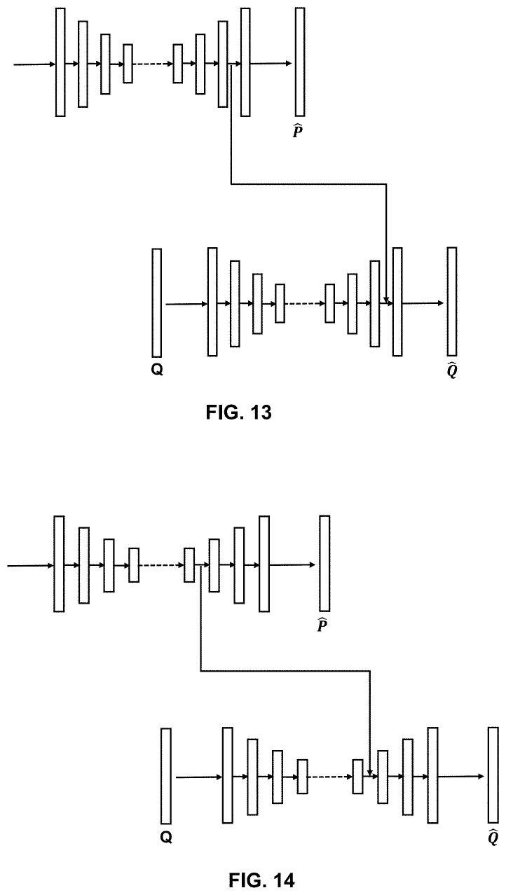

In another example as illustrated in FIG. 14, the latent variables are input from the output of the first layer of the decoder part. In another variant, the latent variables are taken directly as the input of the first layer of the decoder part. This way, the space of “latent transmission” can be very different from the pixel space (e.g., a very distorted version of the pixel space or well decomposed in terms of frequency bands).

Spatial Localization Input

In this embodiment, in order to “specialize” the network on the pixel location in the block, we propose to modify the input of the network. Indeed, the pixel location in the block helps the network to better use the neighboring block information. In all embodiments, the additional input can be used additionally to the input of neighboring blocks (either by reconstruction samples or latent variables).

In one example as illustrated in FIG. 15, two additional channels, with the same size as the input block, are input in the encoder:
The channel H where the value of each pixel goes from 1 to 0 from left to right, i.e., using conventional matrix notation where i range from 1 to h and j from 1 to w: H(i, j)=(j−1)/(w−1).
The channel V where the value of each pixel goes from 1 to 0 from top to bottom, i.e., using conventional matrix notation where i range from 1 to h and j from 1 to w: V(i, j)=(i−1)/(h−1).

In order to give the decoder the same information, the same two channels H and V are input in a secondary network (1510, 1520) having a set of layers similar to the encoder part (successive convolution, down sampling and nonlinear layer) until the resolution matches the input of the layer in the decoder. In FIG. 15, we show the version where the information is input after two layers of the decoder.

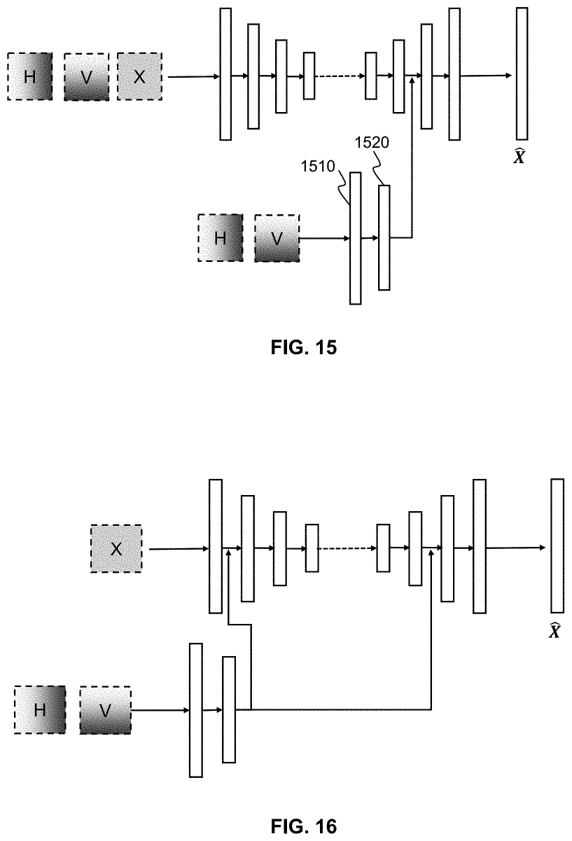

In another example as shown in FIG. 16, the spatial information is symmetric between encoder and decoder and input before a given layer in the encoder and decoder. Note that the input layers of the spatial information can be input at other location in the network, for example the first layer of the encoder/last layer of the decoder, or last layer of the encoder/first layer of the decoder.

In another example, the network is rendered completely spatially aware by replacing the all (or part) the convolution layers by fully connected layers. This method is especially relevant in the case of auto-encoder for small blocks (for example, up to 16×16).

Adaptive Block Size

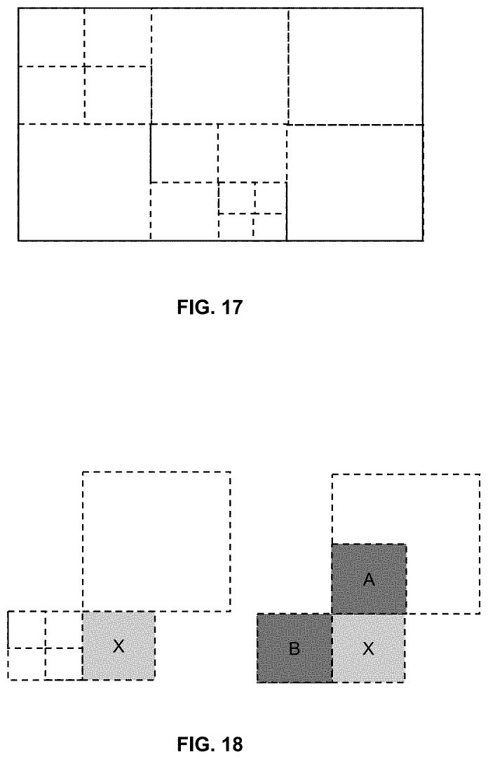

In an embodiment, several auto-encoders are trained for different block sizes. The image is partitioned using different block sizes, as illustrated in FIG. 17. In the following, we describe the proposed method considering quad-tree partitioning, similar to the one used the HEVC standard, where a given starting block size (for example, 256×256) is recursively split into a quad-tree depending on the RD (Rate-Distortion) cost of the best choices of split. It should be noted that the proposed methods apply to other shapes of blocks such as rectangles.

In this embodiment, there exists several auto-encoders:
One for each block size (for example 4×4, 8×8, 16×16 etc. up to 256×256).
For each size, the 4 auto-encoders already described, depending on the block location in the picture.

In this embodiment, the reconstructed pixel values from the neighbors, at the same size as the current block, are considered as input, since neighbor blocks may have different sizes as the current block which makes the latent information unavailable. In FIG. 18, we show an example of neighboring information extraction: virtual blocks A and B are extracted at the top and at the left of the block X to be encoded. Then the same process as described before can be used.

In case of latent input, an approximation of the latent variables is given by re-encoding the virtual block (from reconstructed pixels) in an auto-encoder. The latent variables are then taken from the input of the last layer.

RDO

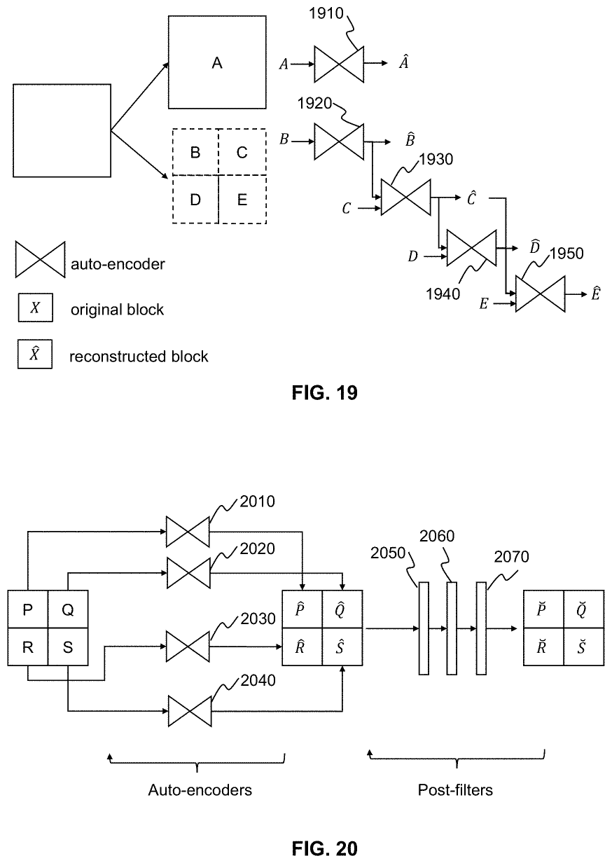

Given several auto-encoders specialized by the block size, a classical Rate-Distortion Optimization (RDO) can be performed outside the auto-encoders as illustrated in FIG. 19:
For a block to be encoded, the full block encoding A (1910) is compared to the encoding of four smaller blocks encoding (B, C D and E, 1920, 1930, 1940, 1950), using the RD costs:

Φ(A)+Δ(R(A)+S0) [symbol] Φ(B)+Φ(C)+Φ(D)+Φ(E)+λ(R(B)+R(C)+R(D)+R(E)+S1)

where Φ( ) is the distortion function (between original and reconstructed block), R( ) is the rate (in bits) of coding the given block, S0 the coding cost of signaling the no split of the block, S1 the coding cost of signaling the split of the block, and λ the trade-off between the distortion and rate. The same method can be applied recursively on each block.

Post-Filtering

In order to remove blocking artifacts between blocks, a post-filter network is trained on the block boundaries. In order to improve the performance, the auto-encoders (2010, 2020, 2030, 2040) and post-filter network (2050, 2060, 2070) can be trained or fined-tuned jointly, for example, using the process shown in FIG. 20. For each four adjacent blocks, the output is sent to the post-filter network. Note that boundaries locations can also be sent as an input to the post-filter network. In a variant, in order to improve the post-filtering process, the latent variables of all auto-encoders are fed to the post-filter network (i.e., the input of the last layer of the encoders after up-sampling).

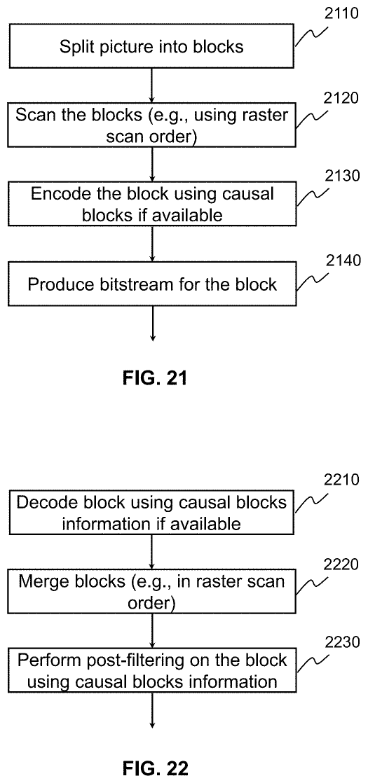

FIG. 21 illustrates a method of encoding a picture using a block-based encoder, according to an embodiment. At step 2110, a picture is split into blocks, for example, as shown in FIG. 5 or FIG. 17. At step 2120, the blocks are scanned, for example, using a raster scan order. In the scanning order, each block is encoded (2130), for example, using auto-encoders as illustrated in FIG. 6. The bitstream is produced (2140) based on the encoding results for the blocks.

FIG. 22 illustrates a method of decoding a picture using a block-based decoder, according to an embodiment. At step 2210, each block is decoded, for example, using decoders corresponding to auto-encoders as illustrated in FIG. 6. At step 2220, the blocks are merged to reconstruct the picture, for example, based on a raster scan order. At step 2230, post-filtering may be performed between blocks using causal blocks.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the neural networks (320, 350, 440) of a video encoder and decoder as shown in FIG. 3 and FIG. 4. Various numeric values are used in the present application. The specific values are for example purposes and the aspects described are not limited to these specific values.

An embodiment provides a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding video data according to the methods described above. One or more embodiments also provide a computer readable storage medium having stored thereon a bitstream generated according to the methods described above. One or more embodiments also provide a method and apparatus for transmitting or receiving the bitstream generated according to the methods described above.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and deconvolution. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for video encoding, comprising:
accessing a picture, said picture partitioned into a plurality of blocks;
forming an input based on at least a block of said picture;
applying a neural network to said input to form output coefficients, said neural network having a plurality of network layers, wherein each network layer of said plurality of network layers performs linear and non-linear operations, wherein at least a neighboring block of said block is also used to form said input to said plurality of network layers, and wherein said neighboring block of said block is mirrored when forming said input; and
entropy encoding said output coefficients.

2-5. (canceled)

6. The method of claim 1, wherein a top neighboring block of said block is mirrored vertically when forming said input, or wherein a left neighboring block of said block is mirrored horizontally when forming said input.

7. (canceled)

8. The method of claim 1, wherein a top-left neighboring block of said block is mirrored horizontally and vertically when forming said input.

9. The method of claim 1, wherein said at least a neighboring block and said block are concatenated to form said input.

10. The method of claim 1, wherein said block is extended to form said input.

11-12. (canceled)

13. The method of claim 1, wherein parameters for said plurality of network layers are trained based on whether, and which, neighboring blocks are already encoded for said block.

14-22. (canceled)

23. A method for video decoding, comprising:
accessing a bitstream including a picture, said picture having a plurality of blocks;
entropy decoding said bitstream to generate a set of values for a block of said plurality of blocks;
applying a neural network to said set of values to generate a block of picture samples for said block, said neural network having a plurality of network layers, wherein each network layer of said plurality of network layers performs linear and non-linear operations, wherein at least a neighboring block of said block is also used to form said input to said plurality of network layers, and wherein said neighboring block of said block is mirrored when forming said input.

24-27. (canceled)

28. The method of claim 27, wherein a top neighboring block of said block is mirrored vertically when forming said input, or wherein a left neighboring block of said block is mirrored horizontally when forming said input.

29. (canceled)

30. The method of claim 27, wherein a top-left neighboring block of said block is mirrored horizontally and vertically when forming said input.

31. The method of claim 27, wherein said at least a neighboring block and said block are concatenated to form said input.

32. The method of claim 27, wherein said block is reconstructed based on a weighted sum of said block and at least an extend portion of one or more extended neighboring blocks.

33-43. (canceled)

44. An apparatus for video encoding, comprising at least one memory and one or more processors, wherein said one or more processors are configured to:
access a picture, said picture partitioned into a plurality of blocks;
form an input based on at least a block of said picture;
apply a neural network to said input to form output coefficients, said neural network having a plurality of network layers, wherein each network layer of said plurality of network layers performs linear and non-linear operations, wherein at least a neighboring block of said block is also used to form said input to said plurality of network layers, and wherein said neighboring block of said block is mirrored when forming said input; and
entropy encode said output coefficients.

45. The apparatus of claim 44, wherein a top neighboring block of said block is mirrored vertically when forming said input, or wherein a left neighboring block of said block is mirrored horizontally when forming said input.

46. The apparatus of claim 44, wherein a top-left neighboring block of said block is mirrored horizontally and vertically when forming said input.

47. The apparatus of claim 44, wherein said at least a neighboring block and said block are concatenated to form said input.

48. An apparatus for video decoding, comprising at least one memory and one or more processors, wherein said one or more processors are configured to:
access a bitstream including a picture, said picture having a plurality of blocks;
entropy decode said bitstream to generate a set of values for a block of said plurality of blocks;
apply a neural network to said set of values to generate a block of picture samples for said block, said neural network having a plurality of network layers, wherein each network layer of said plurality of network layers performs linear and non-linear operations, wherein at least a neighboring block of said block is also used to form said input to said plurality of network layers, and wherein said neighboring block of said block is mirrored when forming said input.

49. The apparatus of claim 48, wherein a top neighboring block of said block is mirrored vertically when forming said input, or wherein a left neighboring block of said block is mirrored horizontally when forming said input.

50. The apparatus of claim 48, wherein a top-left neighboring block of said block is mirrored horizontally and vertically when forming said input.

51. The apparatus of claim 48, wherein said at least a neighboring block and said block are concatenated to form said input.

52. The apparatus of claim 48, wherein said block is reconstructed based on a weighted sum of said block and at least an extend portion of one or more extended neighboring blocks.
